(19) United States
(12) Patent Application Publication
(10) Pub. No.: US 2023/0324009 A1
(43) Pub. Date: Oct. 12, 2023

(54) COMPRESSED HYDROGEN STORAGE UNITS AND METHODS THEREOF

(71) Applicant: FORD GLOBAL TECHNOLOGIES, LLC, Dearborn, MI (US)

(72) Inventors: Viswanath Akella, Ann Arbor, MI (US); Dennis Seung-Man Yang, Canton, MI (US); Michael Jon Veenstra, Southgate, MI (US); Brian Thomas Aitken, Brighton, MI (US)

(21) Appl. No.: 17/715,669

(22) Filed: Apr. 7, 2022

(51) Int. Cl. F17C 13/02; F17C 1/00; B60K 15/073

(52) U.S. Cl. CPC F17C 13/02; F17C 1/00; B60K 15/073; F17C 2201/0109; H01M 8/04201; F17C 2203/0629; F17C 2221/012; F17C 2270/0168; F17C 2201/035

(57) ABSTRACT

A storage tank having a wire or wire winding embedded in the wall of the storage tank is disclosed. The wire may be positioned such that it is compromised if the storage tank is deformed to a certain degree. The wire, for example, may form a helical shape proximate to the outer surface of the wall of the storage tank.

### TECHNICAL FIELD

The present disclosure relates to a storage tank, system, and method thereof for detecting the integrity of the storage tank. More particularly, the storage tank may be a pressurized hydrogen storage tank for fueling a vehicle.

### BACKGROUND

Hydrogen is a zero-carbon fuel that can be used by fuel cells or combustion engines. For example, hydrogen may be used by passenger automobiles such as cars and buses. Hydrogen is even used for propulsion of spacecraft. Compressed hydrogen may be stored in a pressurized storage tank.

### SUMMARY

A vehicle or vehicle system including a storage tank and a controller is disclosed. The storage tank includes a side wall. The side wall defines a cavity and has a wire embedded therein. The wire is connected to a controller. The controller is configured to detect whether the wire is intact.

A storage tank is disclosed. The storage tank includes a body including a side wall. The side wall has inner and outer surfaces. The body and/or side wall defines a cavity. A wire winding is embedded in the side wall between the inner and outer surfaces. The wire is embedded at a depth that is less than the depth a ruinous gouge.

A method of monitoring the integrity of a storage tank is disclosed. The method includes sending a signal via a controller through a wire embedded in the sidewall of a storage container. The controller receives the signal unless the wire is not intact. In response to receiving the signal, the controller continues normal operation such as sending another signal through the wire. However, in response to not receiving the signal, the controller terminates use of the container or alerts a user that the container should be replaced.

### BRIEF DESCRIPTION OF THE DRAWINGS

FIG. 1 is a perspective view of a vehicle system with a storage tank.

FIG. 2 is a perspective view of a storage tank with a quarter-section removed.

FIG. 3A is a schematic cross-section view of a vehicle system with a storage tank.

FIG. 3B is a schematic cross-section view of a vehicle system with a storage tank that may be replaced.

FIG. 4 is a schematic view of another vehicles system with a storage tank.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments of the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Moreover, except where otherwise expressly indicated, all numerical quantities in this disclosure are to be understood as modified by the word “about” in describing the broader scope of this disclosure. Practice within the numerical limits stated is generally preferred. Also, unless expressly stated to the contrary: percent, “parts of,” and ratio values are by weight. The description of a group or class of materials as suitable or preferred for given purpose implies the mixtures of any two or more of the members of the group or class are equally suitable or preferred. A description of constituents in chemical terms refers to the constituents at the time of addition to any combination specified in the description and does not necessarily preclude chemical interactions among the constituents of a mixture once mixed.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

This disclosure is not limited to the specific embodiments and methods described below, as specific components and/or conditions may vary. Furthermore, the terminology used herein is used only for the purpose of describing particular embodiments and is not intended to be limiting in any way.

As used in the specification and the appended claims, the singular form “a,” “an,” and “the” comprise plural referents unless the context clearly indicates otherwise. For example, reference to a component in the singular is intended to comprise a plurality of components.

The term “substantially” or “generally” may be used herein to describe disclosed or claimed embodiments. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

With respect to the terms “comprising,” “consisting of,” and “consisting essentially of,” where one of these three terms is used herein, the presently disclosed and claimed subject matter can include the use of either of the other two terms.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

Processes executed by a vehicle system or vehicle computing system located in a vehicle may be discussed herein, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems. In certain embodiments, particular components of the vehicle associated computing system may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

Execution of processes may be facilitated through use of one or more controllers or processors working alone or in conjunction with each other and executing instructions stored on various non-transitory storage media, such as, but not limited to, flash memory, programmable memory, hard disk drives, etc. Communication between systems and processes may include use of, for example, Bluetooth, Wi-Fi, cellular communication and other suitable wireless and wired communication.

In the illustrative embodiments discussed herein, an exemplary, non-limiting example of a process performable by a computing system may be shown. With respect to each process, it is possible for the computing system executing the process to become, for the limited purpose of executing the process, configured as a special purpose processor to perform the process. All processes need not be performed in their entirety and are understood to be examples of types of processes that may be performed to achieve elements of the invention. Additional steps may be added or removed from the exemplary processes as desired.

With respect to the illustrative embodiments described in the figures showing illustrative process flows, it is noted that a general-purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

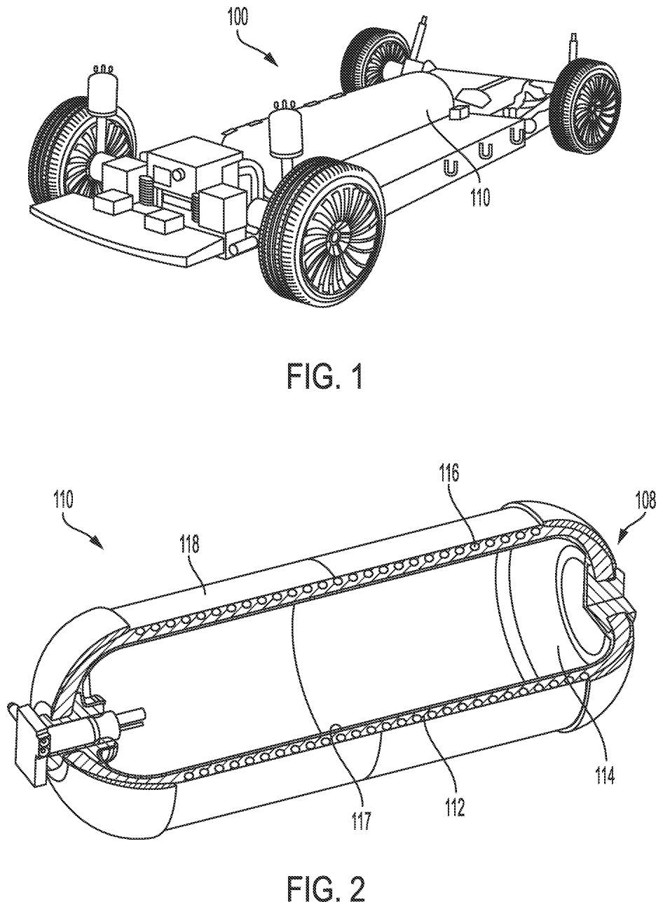

A vehicle system 100, as shown in FIG. 1, including a storage tank 110 and controller 140 is disclosed. The storage tank 110 includes a side wall, outer partition, or containment 112 defining a cavity 114, as shown in FIG. 2. The side wall 112 may include an embedded wire 116. The storage tank 110 may be used to store fuel such as hydrogen or compressed hydrogen. The vehicle system 100 may be a subsystem of a vehicle such as an automobile, motorcycle, train, watercraft, or aircraft.

The storage tank 110 may be any suitable tank, vessel, or container configured for holding a fluid or fuel such as compressed hydrogen, fossil fuels (e.g., gasoline, natural gas, or diesel), biofuels, or kerosene. The storage tank 110 has a body 108 including a side wall, outer partition, or containment wall 112 defining a cavity 114 within the tank, vessel, or container. The side wall, outer partition, or containment wall 112 may be made of metal, metal alloys, or fiber composites such as carbon fiber composites or combinations thereof. The side wall, outer partition, or containment wall 112 may be of a sufficient strength to support the load of, for example, the pressurized fuel. In other words, the storage tank 110 may be configured to withstand a pressurized fluid such as hydrogen gas.

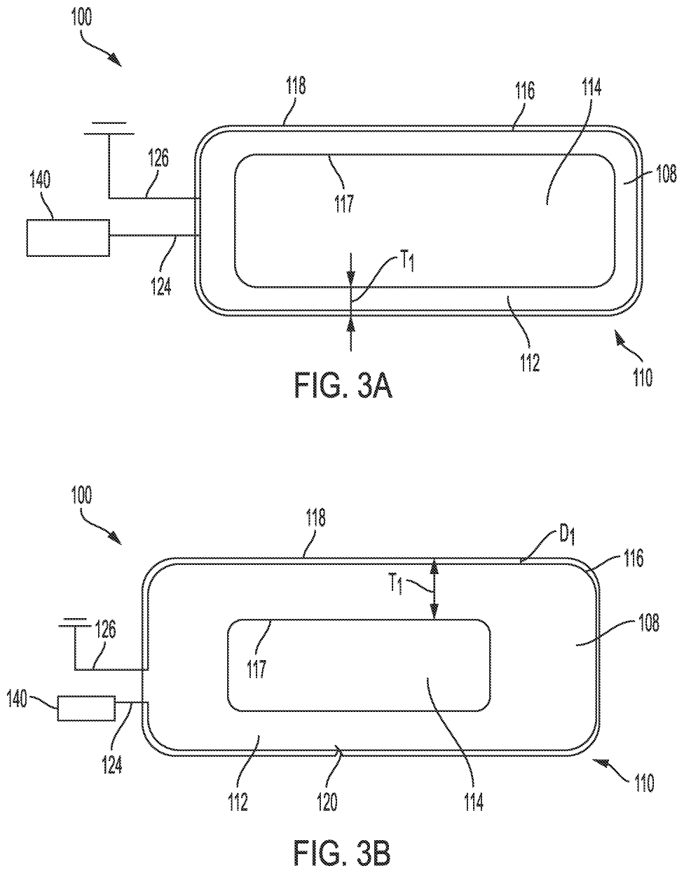

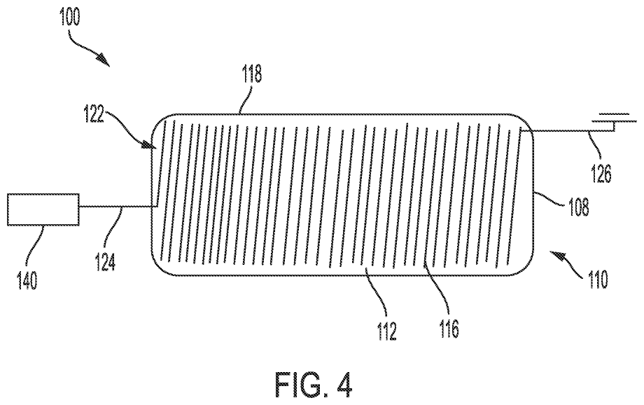

Referring to FIG. 3A, the side wall, outer partition, or containment wall 112 may have inner and outer surfaces 117, 118. The thickness (T₁) of the side wall, outer partition, or containment wall 112 (i.e., the distance between the inner and outer surfaces) may be 10 to 60 mm, or more preferably 20 to 40 mm, or even more preferably 25 to 35 mm. The inner surface 117 may be coated with an impermeable coating or include an inner liner or bladder to prevent the fuel from degrading or permeating through the side wall, outer partition, or containment wall 112. The storage tank 110 may be susceptible to impairment such from an encounter (e.g., blow) with road debris. Minor encounters may be insignificant to the integrity of the storage tank 110.

However, major contact with objects such as road debris or a series minor blows may affect the integrity of the storage tank 110 such that it should no longer be used or should be replaced. For example, a gouge 120 greater than a specific depth and/or width may be considered substantial such that the integrity of the tank 110 has been affected and should no longer be used and should be replaced. Routine replacement or evaluation may be employed to ensure such a storage tank is properly replaced.

A detection system may be employed to detect when the storage tank 102 is no longer suitable and/or should be replaced. For example, a wire 116 may be embedded in the side wall, outer partition or containment wall 112 of the storage tank 102. The wire 116 may be positioned such that it may be severed if the outer surface 118 is punctured to a certain degree. The wire may be positioned proximate to the outer surface 118. For example, the wire 116 may be wound around the cavity 114 such that it forms a web, winding, or coil 122. The web, winding, or coil 122 may be helical shaped as shown in FIG. 4. The wire 116, winding, or coil 122 may be embedded in the side wall, outer partition, or containment wall 112 such that it is between the inner and outer surfaces 117, 118.

The wire 116, web, winding, or coil 122 may be disposed or embedded at a depth (Di) that is less than a problematic gouge or depth. The width between windings may likewise be less than the width of the problematic gouge. The depth and width of a problematic gouge may be calculated based on the tank design such as the side wall thickness, intended life, and material. For example, the wire 116 may be embedded at a depth of no more than 5 mm, more preferably no more than 2 mm, even more preferably no more than 1 mm (e.g., embedded at 0.75 mm) from the outer surface 118 and the width between windings may be no more than 4 mm, or more preferably 3 mm, or even more preferably 2 mm. Said differently, the wire 116 may be embedded less than ¾ the distance from outer surface 118, or more preferably less than ½ the distance, or even more preferably less than ⅓ the distance. The ratio of the thickness (T₁) to the depth (Di) may be 10:1 to 50:1, or more preferably 20:1 to 40:1, or even more preferably 25:1 to 35:1. The ratio of the thickness (T₁) to the width (W₁) may be 2.5:1 to 30:1, or more preferably 5:1 to 25:1, or even more preferably 10:1 to 20:1. The wire 116 may be electrically conductive. For example, the wire 116 may have a conductivity of at least 10³, or more preferably at least 10⁴, or even more preferably at least 10⁶ S/m. The wire may be, for example, a copper wire.

The wire 116 may include leads 124, 126 (e.g., a lead at each end) or be connected to leads 124, 126. The leads may be connected for (electrical) communication with the controller 140. The wire 116 and/or leads 124, 126 may extend from the storage tank 102.

The controller 140 may be configured to detect severing, disfigurement, or impairment of the embedded wire 116. In response to severing, disfigurement, or impairment of the wire the controller 140 may terminate operability of the vehicle/vehicle system or alert a user that replacement/maintenance is necessary. For example, if a rock hits the storage tank 102 it may gouge the outer surface 118 such that it severs the wire 116 which the controller 140 detects, as shown in FIG. 3B. The controller 140 may terminate operability and/or alert the user to replace the storage tank 102 after being severed, disfigured, or impaired. The alert may recommend replacement and/or be a dashboard notification. The controller 140 may detect if the wire 116 has been severed, disfigured, or impaired by sending a signal through the wire 116. The controller 140 will receive the signal as long as the wire 116 is intact or unless the wire 116 is severed, disfigured or impaired. If the controller 140 receives the signal it may continue to operate under normal conditions such as by sending another signal through the wire 116.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle system comprising:
a storage tank having a side wall with an embedded wire therein and defining a cavity; and
a controller connected to the embedded wire such that the controller is configured to detect whether the embedded wire is intact.

2. The vehicle system of claim 1, wherein the embedded wire is wound around the cavity.

3. The vehicle system of claim 2, wherein a width defined between winds of the embedded wire is less than a threshold width.

4. The vehicle system of claim 1, wherein the embedded wire is at a depth from an outer surface of the embedded wire that is less than a threshold depth.

5. The vehicle system of claim 1, wherein the controller is configured to terminate operability of a vehicle responsive to the embedded wire not being intact.

6. The vehicle system of claim 1, wherein the controller is configured to alert a user to replace the storage tank responsive to the embedded wire not being intact.

7. The vehicle system of claim 1, wherein the embedded wire is copper.

8. A storage tank comprising:
a body having a side wall defining a cavity, the side wall having an inner surface and an outer surface; and
a wire winding embedded between the inner and outer surfaces such that the wire winding is at a depth that is less than a predetermined gouge depth.

9. The storage tank of claim 8, wherein the wire winding is copper.

10. The storage tank of claim 8, wherein the wire winding is configured to be connected to leads extending from the body such that the leads are configured for electrical communication with a controller.

11. The storage tank of claim 8, further comprising leads connected to the wire and configured to be connected to a controller.

12. The storage tank of claim 8, wherein the wire winding defines a width between the wire that is less than a predetermined gouge width.

13. The storage tank of claim 8, wherein the depth is no more than 5 mm.

14. The storage tank of claim 8, wherein a ratio of a thickness of the side wall to the depth is 10:1 to 50:1.

15. A method of monitoring the integrity of a hydrogen fuel container comprising:
sending a signal through a wire embedded in a side wall of a tank;
responsive to receiving the signal, sending another signal through the wire; and
responsive to not receiving the signal, executing a command terminating use of the tank or alerting a user to replace the tank.

16. The method of claim 15, wherein the sending is performed by a controller as long as the wire is intact.

17. The method of claim 15, wherein the wire is wound through the side wall of the tank.

18. The method of claim 15, wherein the tank is a fuel tank of a vehicle.
